(19) United States
(12) Patent Application Publication
(10) Pub. No.: US 2026/0025039 A1
(43) Pub. Date: Jan. 22, 2026

(54) COMPRESSOR

(71) Applicant: KABUSHIKI KAISHA TOYOTA JIDOSHOKKI, Kariya-shi (JP)

(72) Inventors: Takayuki KATO, Kariya-shi (JP); Toshiyuki KOBAYASHI, Kariya-shi (JP)

(73) Assignee: KABUSHIKI KAISHA TOYOTA JIDOSHOKKI, Kariya-shi (JP)

(21) Appl. No.: 19/268,096

(22) Filed: Jul. 14, 2025

(30) Foreign Application Priority Data
Jul. 16, 2024 (JP) 2024-113457

(51) Int. Cl. H02K 5/24; F25B 31/02

(52) U.S. Cl. CPC H02K 5/24; F25B 31/02

(57) ABSTRACT

A compressor includes a housing, a sleeve, a pair of vibration-proof elastic members, and a pair of annular plates. The housing includes a mounting foot with a through hole. The sleeve is disposed inside the through hole and a fastening member for fastening the mounting foot to a mounting target is inserted through the sleeve. The pair of vibration-proof elastic members is disposed at both end portions of the through hole in an axial direction of the through hole. One of an inner peripheral surface of the mounting foot and an outer peripheral surface of the sleeve has a radial projection that protrudes in a radial direction toward the other. When the housing vibrates, deformation limits of the vibration-proof elastic members in the radial direction are defined by the radial projection coming into contact with a radial facing surface, in association with deformation of the vibration-proof elastic members.

### CROSS-REFERENCE TO RELATED APPLICATION

This application claims priority to Japanese Patent Application No. 2024-113457 filed on Jul. 16, 2024, the entire disclosure of which is incorporated herein by reference.

### BACKGROUND ART

The present disclosure relates to a compressor.

Japanese Patent Application Publication No. 2022-147643 discloses a conventional compressor. The compressor includes a housing, a pair of sleeves, a pair of vibration-proof elastic members, and a pair of flanges. The compressor is mounted on a mounting target of a vehicle.

The housing includes an accommodation portion and a mounting foot. The accommodation portion accommodates a compression unit that compresses a fluid. A through hole is formed in the mounting foot. Each of the pair of sleeves has a tubular shape and is disposed inside the through hole. One of the pair of sleeves is disposed at one axial end portion of the through hole. The other of the pair of sleeves is disposed at the other axial end portion of the through hole.

The pair of vibration-proof elastic members is disposed at both axial end portions of the through hole of the mounting foot. Each vibration-proof elastic member includes a tubular portion and one of the flanges. The tubular portion is disposed between the inner peripheral surface of the mounting foot and the outer peripheral surface of the sleeve. The flange protrudes in the radial direction from the axial end portion of the tubular portion and is disposed between the mounting foot and an annular plate facing the mounting foot in the axial direction.

In this compressor, the housing vibrates during operation of the compression unit, but the vibration-proof elastic members prevent the vibration from being transmitted to the vehicle.

However, in the above conventional compressor, there is a problem that the vibration-proof elastic members are excessively elastically deformed under severe vibration conditions where an excessive load acts on the vibration-proof elastic members, so that the vibration-proof elastic members are fatigued or cracks occur on the surfaces of the vibration-proof elastic members, resulting in deterioration in vibration-proof performance.

The present disclosure has been made in view of the above conventional circumstances, and is directed to providing a compressor capable of suppressing deterioration in vibration-proof performance of a vibration-proof elastic member even under severe vibration conditions.

### SUMMARY

In accordance with an aspect of the present disclosure, a compressor includes a housing, a sleeve, a pair of vibration-proof elastic members, and a pair of annular plates. The housing includes an accommodation portion accommodating a compression unit that compresses a fluid, and a mounting foot in which a through hole is formed. The sleeve is disposed inside the through hole and a fastening member for fastening the mounting foot to a mounting target is inserted through the sleeve. The sleeve has a tubular shape. The pair of vibration-proof elastic members is disposed at both end portions of the through hole in an axial direction of the through hole and each includes a tubular portion that is disposed between an inner peripheral surface of the mounting foot and an outer peripheral surface of the sleeve. The pair of annular plates is integrated with or separated from the sleeve and disposed outside the vibration-proof elastic members in the axial direction. The pair of annular plates extends in a radial direction orthogonal to the axial direction. The vibration-proof elastic members are compressed in the axial direction between the mounting foot and the annular plates and compressed in the radial direction between the mounting foot and the sleeve. One of the inner peripheral surface of the mounting foot and the outer peripheral surface of the sleeve is provided with a radial projection that protrudes in the radial direction toward the other of the inner peripheral surface of the mounting foot and the outer peripheral surface of the sleeve. When the housing vibrates, deformation limits of the vibration-proof elastic members in the radial direction are defined by the radial projection coming into contact with a radial facing surface of the other that faces the radial projection in the radial direction, in association with deformation of the vibration-proof elastic members.

In accordance with another aspect of the present disclosure, a compressor includes a housing, a sleeve, a pair of vibration-proof elastic members, and a pair of annular plates. The housing includes an accommodation portion accommodating a compression unit that compresses a fluid, and a mounting foot in which a through hole is formed. The sleeve is disposed inside the through hole and a fastening member for fastening the mounting foot to a mounting target is inserted through the sleeve. The sleeve has a tubular shape. The pair of vibration-proof elastic members is disposed at both end portions of the through hole in an axial direction of the through hole and each includes a tubular portion that is disposed between an inner peripheral surface of the mounting foot and an outer peripheral surface of the sleeve. The pair of annular plates is integrated with or separated from the sleeve and disposed outside the vibration-proof elastic members in the axial direction. The pair of annular plates extends in a radial direction orthogonal to the axial direction. The vibration-proof elastic members are compressed in the axial direction between the mounting foot and the annular plates and compressed in the radial direction between the mounting foot and the sleeve. One of a mounting foot end surface of the mounting foot in the axial direction and an annular plate end surface of the annular plate facing the mounting foot end surface in the axial direction is provided with an axial projection that protrudes in the axial direction toward the other of the mounting foot end surface and the annular plate end surface. When the housing vibrates, deformation limits of the vibration-proof elastic members in the axial direction are defined by the axial projection coming into contact with an axial facing surface of the other that faces the axial projection in the axial direction, in association with deformation of the vibration-proof elastic members.

In accordance with yet another aspect of the present disclosure, a compressor includes a housing, a sleeve, a pair of vibration-proof elastic members, and a pair of annular plates. The housing includes an accommodation portion accommodating a compression unit that compresses a fluid, and a mounting foot in which a through hole is formed. The sleeve is disposed inside the through hole and a fastening member for fastening the mounting foot to a mounting target is inserted through the sleeve. The sleeve has a tubular shape. The pair of vibration-proof elastic members is disposed at both end portions of the through hole in an axial direction of the through hole and each includes a tubular portion that is disposed between an inner peripheral surface of the mounting foot and an outer peripheral surface of the sleeve. The pair of annular plates is integrated with or separated from the sleeve and disposed outside the vibration-proof elastic members in the axial direction. The pair of annular plates extends in a radial direction orthogonal to the axial direction. The vibration-proof elastic members are compressed in the axial direction between the mounting foot and the annular plates and compressed in the radial direction between the mounting foot and the sleeve. An axial extension portion extends in the axial direction is provided on a mounting foot end surface of the mounting foot in the axial direction. When the housing vibrates, deformation limits of the vibration-proof elastic members in the radial direction are defined by the axial extension portion coming into contact with an outer peripheral facing surface of the annular plate that faces the axial extension portion in the radial direction, in association with deformation of the vibration-proof elastic members.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a schematic partial cross-sectional view illustrating a compressor of a first embodiment mounted on a vehicle;

FIG. 2 is a cross-sectional view of a first sleeve and a first vibration-proof elastic member, illustrating how the first vibration-proof elastic member is mounted on the first sleeve, according to the compressor of the first embodiment;

FIG. 3 is a partial cross-sectional view of the first sleeve, the first vibration-proof elastic member, a mounting foot, and the like, illustrating the relationship between the protrusion height of a first sleeve-side radial projection provided on an outer peripheral surface of the first sleeve and the thickness of a first tubular portion of the first vibration-proof elastic member in a radial direction of a through hole in both a fastened state of the mounting foot to a mounting target and a non-vibrating state of a housing, according to the compressor of the first embodiment;

FIG. 4 is a partially enlarged cross-sectional view illustrating a state in which a large load has acted on the first vibration-proof elastic member in the radial direction of the through hole according to the compressor of the first embodiment;

FIG. 5 is a schematic partial cross-sectional view illustrating a compressor according to a second embodiment mounted on a vehicle;

FIG. 6 is a partial cross-sectional view of a first sleeve, a first vibration-proof elastic member, a mounting foot, and the like, illustrating the relationship between the protrusion height of a mounting-foot-side radial projection provided on an inner peripheral surface of the mounting foot and the thickness of a first tubular portion of the first vibration-proof elastic member in a radial direction of a through hole in both a fastened state of the mounting foot to a mounting target and a non-vibrating state of a housing, according to the compressor of the second embodiment;

FIG. 7 is a partial cross-sectional view of the mounting foot, the first sleeve, and the first vibration-proof elastic member, illustrating how an integral body of the first vibration-proof elastic member and the first sleeve is inserted into the through hole of the mounting foot, according to the compressor of the second embodiment;

FIG. 8 is a partially enlarged cross-sectional view illustrating a state in which a large load has acted on the first vibration-proof elastic member in the radial direction of the through hole according to the compressor of the second embodiment;

FIG. 9 is a schematic partial cross-sectional view illustrating a compressor according to a third embodiment mounted on a vehicle;

FIG. 10 is a partial cross-sectional view of a first sleeve, a first vibration-proof elastic member, a mounting foot, and the like, illustrating the relationship between the protrusion height of a first flange-side axial projection provided on a first flange end surface of a first flange and the thickness of a first disk portion of the first vibration-proof elastic member in an axial direction of a through hole in both a fastened state of the mounting foot to a mounting target and a non-vibrating state of a housing, according to the compressor of the third embodiment;

FIG. 11 is a partially enlarged cross-sectional view illustrating a state in which a large load has acted on the first vibration-proof elastic member in the axial direction of the through hole according to the compressor of the third embodiment;

FIG. 12 is a schematic partial cross-sectional view illustrating a compressor of a fourth embodiment mounted on a vehicle;

FIG. 13 is a partial cross-sectional view of a first sleeve, a first vibration-proof elastic member, a mounting foot, and the like, illustrating the relationship between the protrusion height of a first mounting-foot-side axial projection provided on a first mounting foot end surface of the mounting foot and the thickness of a first disk portion of the first vibration-proof elastic member in an axial direction of a through hole in both a fastened state of the mounting foot to a mounting target and a non-vibrating state of a housing, according to the compressor of the fourth embodiment;

FIG. 14 is a partially enlarged cross-sectional view illustrating a state in which a large load has acted on the first vibration-proof elastic member in the axial direction of the through hole according to the compressor of the fourth embodiment;

FIG. 15 is a schematic partial cross-sectional view illustrating a compressor according to a fifth embodiment mounted on a vehicle;

FIG. 16 is a partially enlarged cross-sectional view illustrating a state in which a large load has acted on a first vibration-proof elastic member in a radial direction of a through hole according to the compressor of the fifth embodiment;

FIG. 17 is a schematic partial cross-sectional view illustrating a compressor of a sixth embodiment mounted on a vehicle;

FIG. 18 is a partially enlarged cross-sectional view illustrating a compressor of a seventh embodiment mounted on a vehicle;

FIG. 19 is a partially enlarged cross-sectional view illustrating a compressor of an eighth embodiment mounted on a vehicle; and

FIG. 20 is a partially enlarged cross-sectional view illustrating a compressor of a ninth embodiment mounted on a vehicle.

### DETAILED DESCRIPTION OF THE EMBODIMENTS

Hereinafter, first to ninth embodiments, which embody the present disclosure, will be described with reference to the drawings.

### First Embodiment

A compressor 1 of a first embodiment is an example of a specific aspect of the compressor of the present disclosure and is specifically a scroll type electric compressor. The compressor 1 is installed in a vehicle and used in a vehicle air conditioner, for example.

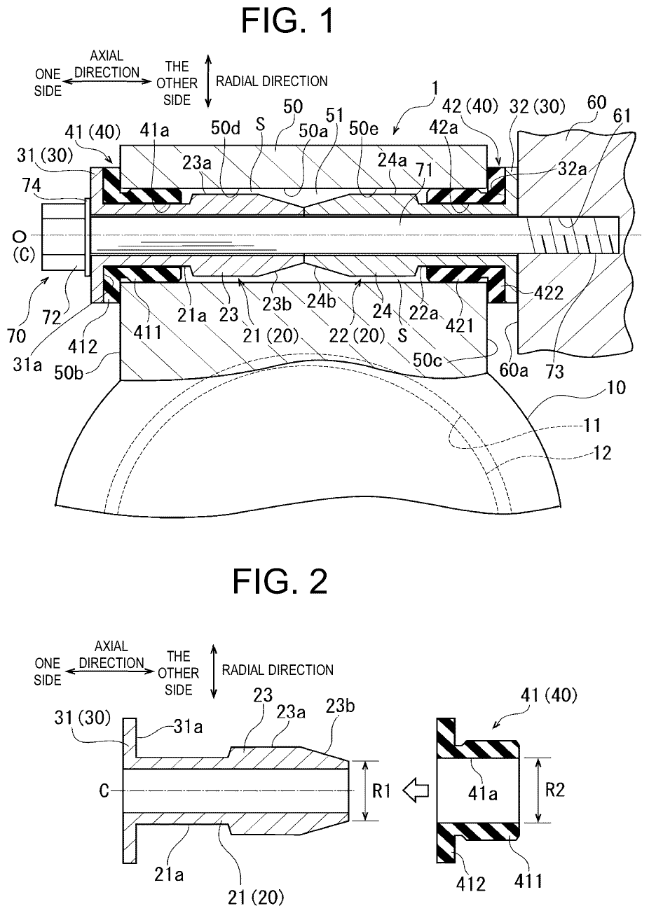

As illustrated in FIG. 1, the compressor 1 includes a housing 10, a pair of sleeves 20, a pair of flanges 30, and a pair of vibration-proof elastic members 40. The flange 30 is an example of an “annular plate” in the present disclosure.

The housing 10 is made of metal, for example, aluminum. The housing 10 includes a tubular accommodation portion 11 and a plurality of mounting feet 50.

A compression unit 12 is accommodated in the accommodation portion 11. The compression unit 12 compresses a refrigerant. The refrigerant is an example of a “fluid” in the present disclosure. Note that the fluid to be compressed by the compression unit 12 is not limited to the refrigerant and may be air or the like.

Although not illustrated, an electric motor, a rotary shaft, and an inverter are accommodated in the accommodation portion 11. The rotary shaft is supported by the housing 10 in a rotatable state in the accommodation portion 11. The electric motor is connected to the compression unit 12 via the rotary shaft and drives the compression unit 12. The inverter is electrically connected to the electric motor and drives and controls the electric motor.

Although not illustrated, a suction port through which the refrigerant is sucked and a discharge port through which the refrigerant is discharged are formed in the housing 10. When the electric motor is driven by the control of the inverter and the rotary shaft is rotated, the compression unit 12 operates. When the compression unit 12 operates, the refrigerant sucked from the suction port is compressed by the compression unit 12, and the compressed refrigerant is discharged from the discharge port to the outside of the housing 10.

The plurality of mounting feet 50 are provided on the outer peripheral surface of the housing 10. In the present embodiment, the three mounting feet 50 are formed integrally with the housing 10. That is, the mounting feet 50 are made of the same metal as the housing 10. As illustrated in FIG. 1, one of the three mounting feet 50 is provided on the upper portion of the outer peripheral surface of the housing 10. Although not illustrated, the remaining two of the three mounting feet 50 are provided at the lower portion of the outer peripheral surface of the housing 10. These mounting feet 50 are provided to mount the housing 10 to a mounting target 60 that is a part of the vehicle.

Each mounting foot 50 has a cylindrical shape. A central axis O of each mounting foot 50 extends in a direction orthogonal to the central axis of the accommodation portion 11 and in the horizontal direction. In the present embodiment, the central axis of the accommodation portion 11 coincides with the rotation axis of the rotary shaft.

Since each mounting foot 50 has the same configuration, in the following description, the one mounting foot 50 provided on the upper portion of the housing 10 among the three mounting feet 50 will be described, and the description of the other mounting feet 50 will be omitted. In the present embodiment, one axial side of a through hole 51 of the mounting foot 50 and the other axial side of the through hole 51 are defined by a solid arrow illustrated in FIG. 1. In FIG. 2 and subsequent figures, one axial side and the other axial side are defined in correspondence with FIG. 1. In the following description, as illustrated in FIG. 1, the arrangement and positional relationship of the members in a fastened state where the mounting foot 50 is fastened to the mounting target 60 will be described.

The through hole 51 penetrating the mounting foot 50 in the central axis O direction is formed in the mounting foot 50. The axial direction of the through hole 51 extends parallel to the central axis O of the mounting foot 50. The through hole 51 is formed inside the mounting foot 50 by an inner peripheral surface 50a of the mounting foot 50. The inner peripheral surface 50a extends over the entire through 20 hole 51 in the axial direction with a constant inner diameter.

The mounting foot 50 includes a first mounting foot end surface 50b on the one axial side and a second mounting foot end surface 50c on the other axial side. The first mounting foot end surface 50b and the second mounting foot end surface 50c are planes orthogonal to the central axis O. The second mounting foot end surface 50c faces and is adjacent to a mounting end surface 60a of the mounting target 60 in the axial direction. A female screw 61 extending in the axial direction is formed at the position of the mounting end surface 60a so as to correspond to the central axis O of the mounting foot 50 disposed at the mounting position.

The pair of sleeves 20 is made of metal, for example, aluminum. The pair of sleeves 20 is disposed inside the through hole 51. The pair of sleeves 20 is a first sleeve 21 and a second sleeve 22. The first sleeve 21 is disposed at one axial end portion of the through hole 51. The second sleeve 22 is disposed at the other axial end portion of the through hole 51.

As illustrated in FIG. 2, the first sleeve 21 has a substantially cylindrical shape with a central axis C. The inner diameter of the first sleeve 21 is slightly larger than an outer diameter of a shaft portion 71 of a fastening member 70, which will be described later. A first sleeve-side radial projection 23 is formed on a first outer peripheral surface 21a of the first sleeve 21. The first sleeve-side radial projection 23 is an example of a “radial projection” in the present disclosure. The first sleeve-side radial projection 23 is integrally formed at the other axial end portion of the first outer peripheral surface 21a of the first sleeve 21. The first sleeve-side radial projection 23 annularly protrudes radially outward from the first outer peripheral surface 21a of the first sleeve 21. In the axial direction, the length of the first sleeve-side radial projection 23 is ⅓ or more of the length of the first sleeve 21. The first outer peripheral surface 21a of the first sleeve 21 extends in the axial direction of the through hole 51 with a constant outer diameter from one end portion of the first sleeve 21 to the first sleeve-side radial projection 23.

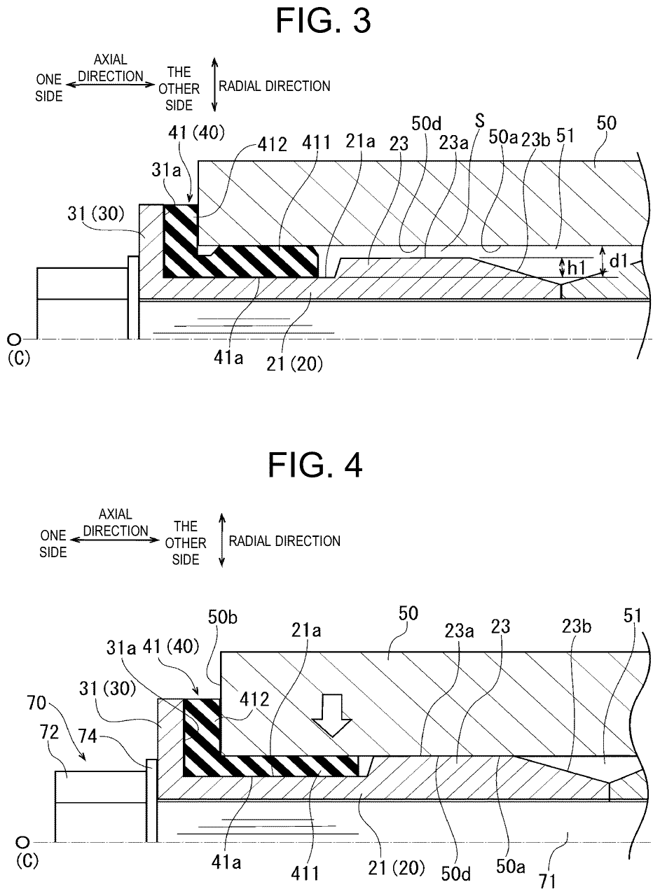

The first sleeve-side radial projection 23 protrudes from the first outer peripheral surface 21a of the first sleeve 21 at a predetermined protrusion height. The first sleeve-side radial projection 23 includes a first outer peripheral contact surface 23a and a first tapered outer peripheral surface 23b. The first outer peripheral contact surface 23a extends in the axial direction with a constant outer 25 diameter. As illustrated in FIG. 3, in the radial direction orthogonal to the axial direction, a protrusion height h1 of the first sleeve-side radial projection 23 on the first outer peripheral contact surface 23a is ⅔ or more of a thickness d1 of a first tubular portion 411, which will be described later, in both the fastened state of the mounting foot 50 to the mounting target 60 and the non-vibrating state of the housing 10.

The outer diameter of the first sleeve-side radial projection 23 on the first outer peripheral contact surface 23a is smaller than the inner diameter of the through hole 51 of the mounting foot 50 by a predetermined amount. As illustrated in FIG. 1, in the state where the mounting foot 50 is fastened to the mounting target 60, a predetermined gap S is provided in the radial direction between the first outer peripheral contact surface 23a of the first sleeve-side radial projection 23 and a first mounting-foot-side radial facing surface 50d radially facing the first outer peripheral contact surface 23a on the inner peripheral surface 50a of the mounting foot 50. The first mounting-foot-side radial facing surface 50d is an example of a “radial facing surface” in the present disclosure.

As illustrated in FIG. 2, the first tapered outer peripheral surface 23b is formed at the other axial end portion of the first sleeve-side radial projection 23. The first tapered outer peripheral surface 23b is tapered toward the other distal end in the axial direction. The outer diameter of the other axial distal end of the first sleeve 21, that is, the minimum outer diameter of the other axial distal end of the first tapered outer peripheral surface 23b, is R1. The minimum outer diameter R1 of the distal end of the first tapered outer peripheral surface 23b is smaller by a predetermined amount than an inner diameter R2 of a first vibration-proof elastic member 41, which will be described later.

The second sleeve 22 has a substantially cylindrical shape with a central axis C and has a similar configuration to the first sleeve 21. The inner diameter of the second sleeve 22 is slightly larger than the outer diameter of the shaft portion 71 of the fastening member 70, which will be described later. A second sleeve-side radial projection 24 is formed on a second outer peripheral surface 22a of the second sleeve 22. The second sleeve-side radial projection 24 is an example of the “radial projection” in the present disclosure. The second sleeve-side radial projection 24 is integrally formed at one axial end portion of the second outer peripheral surface 22a of the second sleeve 22. The second sleeve-side radial projection 24 annularly protrudes radially outward from the second outer peripheral surface 22a of the second sleeve 22. In the axial direction, the length of the second sleeve-side radial projection 24 is ⅓ or more of the length of the second sleeve 22. The second outer peripheral surface 22a of the second sleeve 22 extends in the axial direction of the through hole 51 with a constant outer diameter from the other end portion of the second sleeve 22 to the second sleeve-side radial projection 24.

The second sleeve-side radial projection 24 protrudes from the second outer peripheral surface 22a of the second sleeve 22 at a predetermined protrusion height. The second sleeve-side radial projection 24 includes a second outer peripheral contact surface 24a and a second tapered outer peripheral surface 24b. The second outer peripheral contact surface 24a extends in the axial direction with a constant outer diameter. In the radial direction orthogonal to the axial direction, a protrusion height h1 of the second sleeve-side radial projection 24 on the second outer peripheral contact surface 24a is ⅔ or more of a thickness d1 of a second tubular portion 421, which will be described later, in both the fastened state of the mounting foot 50 to the mounting target 60 and the non-vibrating state of the housing 10.

The outer diameter of the second sleeve-side radial projection 24 on the second outer peripheral contact surface 24a is smaller than the inner diameter of the through hole 51 of the mounting foot 50 by a predetermined amount. As illustrated in FIG. 1, in the state where the mounting foot 50 is fastened to the mounting target 60, a predetermined gap S is provided in the radial direction between the second outer peripheral contact surface 24a of the second sleeve-side radial projection 24 and a second mounting-foot-side radial facing surface 50e radially facing the second outer peripheral contact surface 24a on the inner peripheral surface 50a of the mounting foot 50. The second mounting-foot-side radial facing surface 50e is an example of the “radial facing surface” in the present disclosure.

The second tapered outer peripheral surface 24b is formed at one axial end portion of the second sleeve-side radial projection 24. The second tapered outer peripheral surface 24b is tapered toward one axial distal end. The outer diameter of the one axial distal end of the second sleeve 22, that is, the minimum outer diameter of the one axial distal end of the second tapered outer peripheral surface 24b, is R1. The minimum outer diameter R1 of the distal end of the second tapered outer peripheral surface 24b is smaller by a predetermined amount than an inner diameter R2 of a second vibration-proof elastic member 42, which will be described later.

The pair of flanges 30 is a first flange 31 and a second flange 32. The first sleeve 21 integrally includes the first flange 31. The second sleeve 22 integrally includes the second flange 32.

The first flange 31 is integrally formed at one axial end portion of the first sleeve 21. That is, in the present embodiment, the flange 30 as an annular plate is integrally formed on the sleeve 20. The first flange 31 is made of the same metal as the first sleeve 21. The first flange 31 protrudes radially outward from the one axial end portion of the first sleeve 21 and extends in a disk shape. The first flange 31 is located closer to the one axial side than the first mounting foot end surface 50b of the mounting foot 50 is. The first flange 31 includes a first flange end surface 31a axially facing the first mounting foot end surface 50b. The first flange 31 is located closer to the one axial side than a first disk portion 412, which will be described later, is.

The second flange 32 is integrally formed at the other axial end portion of the second sleeve 22. The second flange 32 is made of the same metal as the second sleeve 22. The second flange 32 protrudes radially outward from the other axial end portion of the second sleeve 22 and extends in a disk shape. The second flange 32 is located closer to the other axial side than the second mounting foot end surface 50c of the mounting foot 50 is. The second flange 32 includes a second flange end surface 32a axially facing the second mounting foot end surface 50c. The second flange 32 is located closer to the other axial side than a second disk portion 422, which will be described later, is.

As illustrated in FIG. 1, a head portion 72 of a fastening member 70, which will be described later, is in contact with the first flange 31 via a washer 74. The second flange 32 is in contact with the mounting end surface 60a of the mounting target 60. The other axial end portion of the first sleeve 21 and one axial end portion of the second sleeve 22 are in contact with each other.

The pair of vibration-proof elastic members 40 is disposed at both axial end portions of the through hole 51. The pair of vibration-proof elastic members 40 is made of a tubular rubber elastic body. The pair of vibration-proof elastic members 40 includes the first vibration-proof elastic member 41 and the second vibration-proof elastic member 42.

The first vibration-proof elastic member 41 is disposed at one axial end portion of the through hole 51. The first vibration-proof elastic member 41 is disposed between the inner peripheral surface 50a of the mounting foot 50 and the first outer peripheral surface 21a of the first sleeve 21. The first vibration-proof elastic member 41 is disposed between the first flange 31 and the first sleeve-side radial projection 23 in the axial direction. The inner diameter R2 of the first vibration-proof elastic member 41 is slightly smaller than the outer diameter of the first outer peripheral surface 21a other than the first sleeve-side radial projection 23 in the first sleeve 21.

The first vibration-proof elastic member 41 includes the first tubular portion 411 and the first disk portion 412. The first tubular portion 411 is an example of a “tubular portion” in the present disclosure.

The first tubular portion 411 is disposed between the inner peripheral surface 50a of the mounting foot 50 and the first outer peripheral surface 21a of the first sleeve 21 in the radial direction. The first tubular portion 411 has a cylindrical shape that is thick in the radial direction and extends in the axial direction. The thickness of the first tubular portion 411 in the radial direction is d1 in both the fastened state where the mounting foot 50 is fastened to the mounting target 60 and the non-vibrating state where the housing 10 is not vibrating.

The first disk portion 412 is integrally formed at one axial end portion of the first tubular portion 411. The first disk portion 412 protrudes in the radial direction from one axial end portion of the first tubular portion 411 and extends in a disk shape. In a state where an external force does not act on the first vibration-proof elastic member 41, the thickness of the first disk portion 412 in the axial direction is made larger than the thickness of the first tubular portion 411 in the radial direction by a predetermined amount. The outer diameter of the first tubular portion 411 is slightly larger than the inner diameter of the through hole 51 of the mounting foot 50.

As illustrated in FIG. 1, in the state where the mounting foot 50 is fastened to the mounting target 60, the first tubular portion 411 of the first vibration-proof elastic member 41 is compressed in the radial direction between the inner peripheral surface 50a of the mounting foot 50 and the first outer peripheral surface 21a of the first sleeve 21, and the first disk portion 412 of the first vibration-proof elastic member 41 is compressed in the axial direction between the first mounting foot end surface 50b of the mounting foot 50 and the first flange end surface 31a of the first flange 31.

The second vibration-proof elastic member 42 is disposed at the other axial end portion of the through hole 51. The second vibration-proof elastic member 42 is disposed between the inner peripheral surface 50a of the mounting foot 50 and the second outer peripheral surface 22a of the second sleeve 22. The second vibration-proof elastic member 42 is disposed between the second flange 32 and the second sleeve-side radial projection 24 in the axial direction. The inner diameter R2 of the second vibration-proof elastic member 42 is slightly smaller than the outer diameter of the second outer peripheral surface 22a other than the second sleeve-side radial projection 24 in the second sleeve 22.

The second vibration-proof elastic member 42 includes the second tubular portion 421 and the second disk portion 422. The second tubular portion 421 is an example of the “tubular portion” in the present disclosure.

The second tubular portion 421 is disposed between the inner peripheral surface 50a of the mounting foot 50 and the second outer peripheral surface 22a of the second sleeve 22 in the radial direction. The second tubular portion 421 has a cylindrical shape thick in the radial direction and extends in the axial direction. The thickness of the second tubular portion 421 in the radial direction is d1 in both 10) the fastened state where the mounting foot 50 is fastened to the mounting target 60 and the non-vibrating state where the housing 10 is not vibrating.

The second disk portion 422 is integrally formed at the other axial end portion of the second tubular portion 421. The second disk portion 422 protrudes in the radial direction from the other axial end portion of the second tubular portion 421 and extends in a disk shape. In a state where an external force does not act on the second vibration-proof elastic member 42, the thickness of the second disk portion 422 in the axial direction is made larger than the thickness of the second tubular portion 421 in the radial direction by a predetermined amount. The outer diameter of the second tubular portion 421 is slightly larger than the inner diameter of the through hole 51 of the mounting foot 50.

As illustrated in FIG. 1, in the state where the mounting foot 50 is fastened to the mounting target 60, the second tubular portion 421 of the second vibration-proof elastic member 42 is compressed in the radial direction between the inner peripheral surface 50a of the mounting foot 50 and the second outer peripheral surface 22a of the second sleeve 22, and the second disk portion 422 of the second vibration-proof elastic member 42 is compressed in the axial direction between the second mounting foot end surface 50c of the mounting foot 50 and the second flange end surface 32a of the second flange 32.

The fastening member 70 is inserted into the pair of sleeves 20. The fastening member 70 includes the shaft portion 71 and the head portion 72. The shaft portion 71 includes a male screw 73 at the other axial end portion. The distal end of the shaft portion 71 inserted from the first flange 31 into the first sleeve 21 extends from the second flange 32 to the other axial side, and the male screw 73 5 is screwed into the female screw 61 of the mounting target 60.

The mounting foot 50 is mounted on the mounting target 60 as follows, for example.

As illustrated in FIG. 2, the first vibration-proof elastic member 41 is mounted on the first sleeve 21. At this time, an inner peripheral surface 41a of the first vibration-proof elastic member 41 is brought into contact with and slid on the first tapered outer peripheral surface 23b of the first sleeve-side radial projection 23. Thus, the diameter of the first vibration-proof elastic member 41 can be easily increased on the first tapered outer peripheral surface 23b. This makes it easier for the first vibration-proof elastic member 41 to pass over the first sleeve-side radial projection 23, facilitating the mounting of the first vibration-proof elastic member 41 on the first sleeve 21. The second vibration-proof elastic member 42 is similarly mounted on the second sleeve 22.

Then, an integral body of the first sleeve 21 and the first vibration-proof elastic member 41 is inserted into the through hole 51 of the mounting foot 50 from the one axial side. At this time, the first tubular portion 411 of the first vibration-proof elastic member 41 is press-fitted into the through hole 51. The first disk portion 412 of the first vibration-proof elastic member 41 is brought into contact with the first mounting foot end surface 50b of the mounting foot 50. Similarly, an integral body of the second sleeve 22 and the second vibration-proof elastic member 42 is inserted into the through hole 51 of the mounting foot 50 from the other axial side, the second tubular portion 421 of the second vibration-proof elastic member 42 is press-fitted into the through hole 51, and the second disk portion 422 of the second vibration-proof elastic member 42 is brought into contact with the second mounting foot end surface 50c of the mounting foot 50.

The first vibration-proof elastic member 41 may be inserted into the through hole 51 of the mounting foot 50 from the one axial side, and then the first sleeve 21 may be inserted into the space within the inner peripheral surface 41a of the first vibration-proof elastic member 41. Similarly, the second vibration-proof elastic member 42 may be inserted into the through hole 51 of the mounting foot 50 from the other axial side, and then the second sleeve 22 may be inserted into the space within an inner peripheral surface 42a of the second vibration-proof elastic member 42.

Then, with the mounting foot 50 disposed at a predetermined position with respect to the mounting target 60, the shaft portion 71 of the fastening member 70 is inserted into the pair of sleeves 20, and the male screw 73 is screwed into the female screw 61 of the mounting target 60. The mounting foot 50 is thus fastened to the mounting target 60 by the fastening member 70, and the mounting of the mounting foot 50 to the mounting target 60 is completed.

In the fastened state where the mounting foot 50 is fastened to the mounting target 60, the first tubular portion 411 of the first vibration-proof elastic member 41 is compressed in the radial direction, and the first disk portion 412 of the first vibration-proof elastic member 41 is compressed in the axial direction. Similarly, in this fastened state, the second tubular portion 421 of the second vibration-proof elastic member 42 is compressed in the radial direction, and the second disk portion 422 of the second vibration-proof elastic member 42 is compressed in the axial direction.

Therefore, in the compressor 1, when the compression unit 12 operates and the housing 10 vibrates, the axial vibration component and the radial vibration component of the through hole 51 are attenuated by the first vibration-proof elastic member 41 and the second vibration-proof elastic member 42. Specifically, when the housing 10 vibrates in the axial direction, the axial vibration component is attenuated by the first disk portion 412 of the first vibration-proof elastic member 41 and the second disk portion 422 of the second vibration-proof elastic member 42. When the housing 10 vibrates in the radial direction, the radial vibration component is attenuated by the first tubular portion 411 of the first vibration-proof elastic member 41 and the second tubular portion 421 of the second vibration-proof elastic member 42.

When the housing 10 greatly vibrates in the radial direction of the through hole 51 under severe vibration conditions, an excessive load in the radial direction acts on the first vibration-proof elastic member 41 and the second vibration-proof elastic member 42. Thus, the first tubular portion 411 of the first vibration-proof elastic member 41 and the second tubular portion 421 of the second vibration-proof elastic member 42 tend to greatly deform in the radial direction.

In this regard, in the compressor 1, as illustrated in FIG. 4, when the mounting foot 50 is displaced in the radial direction with respect to the sleeve 20 in association with radial elastic deformation of the first tubular portion 411 and the second tubular portion 421, the first outer peripheral contact surface 23a of the first sleeve-side radial projection 23 and the first mounting-foot-side radial facing surface 50d come into contact with each other, and the second outer peripheral contact surface 24a of the second sleeve-side radial projection 24 and the second mounting-foot-side radial facing surface 50e come into contact with each other. This restricts further radial deformation of the first tubular portion 411 of the first vibration-proof elastic member 41 and the second tubular portion 421 of the second vibration-proof elastic member 42. As a result, the deformation limit of the first tubular portion 411 in the radial direction is defined, and the deformation limit of the second tubular portion 421 in the radial direction is defined.

Thus, in the compressor 1, even under severe conditions where the housing 10 greatly vibrates in the radial direction, the first tubular portion 411 of the first vibration-proof elastic member 41 and the second tubular portion 421 of the second vibration-proof elastic member 42 are prevented from being excessively elastically deformed in the radial direction. As a result, it is possible to suppress the fatigue of the vibration-proof elastic member 40 and the occurrence of cracks on the surface of the vibration-proof elastic member 40.

In particular, in the compressor 1, the protrusion height h1 of the first sleeve-side radial projection 23 is ⅔ or more of the thickness d1 of the first tubular portion 411 in the radial direction in both the fastened state of the mounting foot 50 to the mounting target 60 and the non-vibrating state of the housing 10. Depending on the relationship with the volume, rubber hardness, and the like of the first vibration-proof elastic member 41, by setting the deformation amount of the first tubular portion 411 in the radial direction to less than about ⅓ of the thickness d1 of the first tubular portion 411, rubber deterioration in the first tubular portion 411 and damage occurring at the boundary between the first tubular portion 411 and the first disk portion 412 can be suitably suppressed. The same applies to the second vibration-proof elastic member 42.

Therefore, the compressor 1 can suppress deterioration in the vibration-proof performance of the vibration-proof elastic member 40 even under severe vibration conditions.

### Second Embodiment

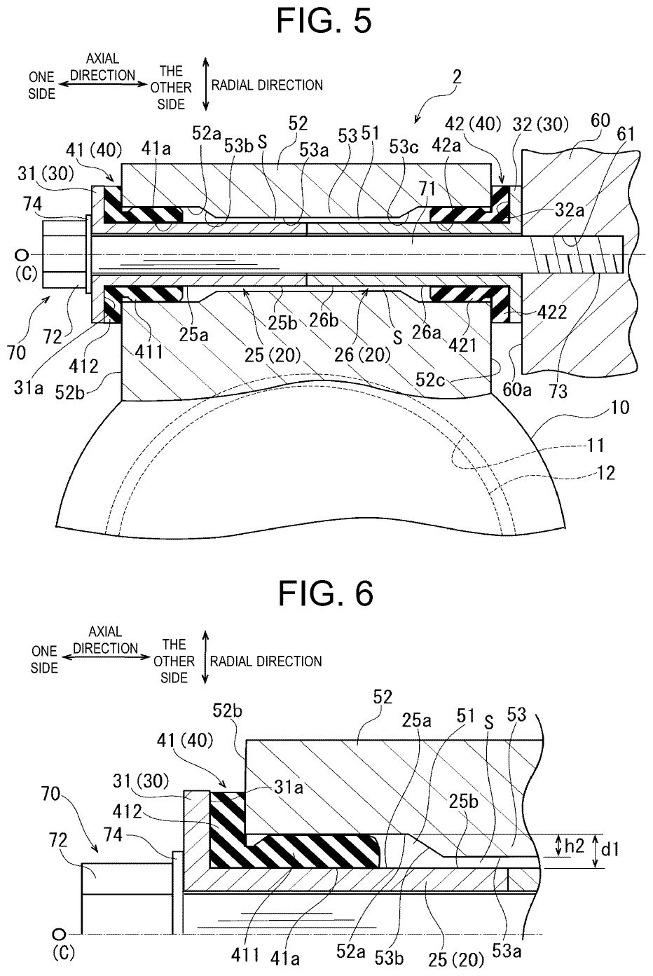

A compressor 2 of a second embodiment illustrated in FIG. 5 is a modification of the compressor 1 of the first embodiment. In the compressor 2, a mounting-foot-side radial projection 53 is provided on an inner peripheral surface 52a of a mounting foot 52. The mounting-foot-side radial projection 53 is an example of the “radial projection” in the present disclosure.

The mounting-foot-side radial projection 53 annularly protrudes radially inward from the inner peripheral surface 52a of the mounting foot 52. In the axial direction of the through hole 51, the mounting-foot-side radial projection 53 is provided at the central portion of the inner peripheral surface 52a. In the axial direction of the through hole 51, the length of the mounting-foot-side radial projection 53 is ⅓ or more of the entire length of the inner peripheral surface 52a.

The inner peripheral surface 52a of the mounting foot 52 extends in the axial direction of the through hole 51 with a constant inner diameter from one end portion of the mounting foot 52 to the mounting-foot-side radial projection 53. The inner peripheral surface 52a of the mounting foot 52 extends in the axial direction of the through hole 51 with a constant inner diameter from the other end portion of the mounting foot 52 to the mounting-foot-side radial projection 53.

The mounting-foot-side radial projection 53 includes an inner peripheral contact surface 53a, a first tapered inner peripheral surface 53b, and a second tapered inner peripheral surface 53c. The first tapered inner peripheral surface 53b and the second tapered inner peripheral surface 53c are examples of a “tapered inner peripheral surface” in the present disclosure.

In the axial direction of the through hole 51, the length of the inner peripheral contact surface 53a is ⅓ or more of the entire length of the inner peripheral surface 52a. The inner peripheral contact surface 53a extends in the axial direction with a constant inner diameter. The first tapered inner peripheral surface 53b is formed at one axial end portion of the mounting-foot-side radial projection 53. The inner diameter of the first tapered inner peripheral surface 53b gradually decreases from one axial end toward the other axial side of the mounting-foot-side radial projection 53. The second tapered inner peripheral surface 53c is formed at the other axial end portion of the mounting-foot-side radial projection 53. The inner diameter of the second tapered inner peripheral surface 53c gradually decreases from the other axial end toward the one axial side of the mounting-foot-side radial projection 53.

The pair of sleeves 20 is a first sleeve 25 and a second sleeve 26. The first sleeve 25 has a cylindrical shape extending in the axial direction with a constant outer diameter. Similarly, the second sleeve 26 has a cylindrical shape extending in the axial direction with a constant outer diameter.

Similarly to the compressor 1 of the first embodiment, the pair of flanges 30 is the first flange 31 and the second flange 32. The first flange 31 is integrally formed at one axial end portion of the first sleeve 25. The first flange 31 protrudes radially outward from the one axial end portion of the first sleeve 25 and extends in a disk shape. Similarly, the second flange 32 is integrally formed at the other axial end portion of the second sleeve 26. The second flange 32 protrudes radially outward from the other axial end portion of the second sleeve 26 and extends in a disk shape.

The inner diameter of the mounting-foot-side radial projection 53 is larger than the outer diameter of the first sleeve 25 and the outer diameter of the second sleeve 26 by a predetermined amount. The mounting-foot-side radial projection 53 protrudes from the inner peripheral surface 52a of the mounting foot 52 at a predetermined protrusion height. As illustrated in FIG. 6, in the radial direction orthogonal to the axial direction, a protrusion height h2 of the mounting-foot-side radial projection 53 on the inner peripheral contact surface 53a is ⅔ or more of the thickness d1 of the first tubular portion 411 in both the fastened state of the mounting foot 52 to the mounting target 60 and the non-vibrating state of the housing 10. A predetermined gap S is provided in the radial direction between the inner peripheral contact surface 53a of the mounting-foot-side radial projection 53 and a first sleeve-side radial facing surface 25b radially facing an inner peripheral contact surface 53a on a first outer peripheral surface 25a of the first sleeve 25. The first sleeve-side radial facing surface 25b is an example of the “radial facing surface” in the present disclosure. Similarly, as illustrated in FIG. 5, a predetermined gap S is provided in the radial direction between the inner peripheral contact surface 53a of the mounting-foot-side radial projection 53 and a second sleeve-side radial facing surface 26b radially facing the inner peripheral contact surface 53a on a second outer peripheral surface 26a of the second sleeve 26. The second sleeve-side radial facing surface 26b is an example of the “radial facing surface” in the present disclosure.

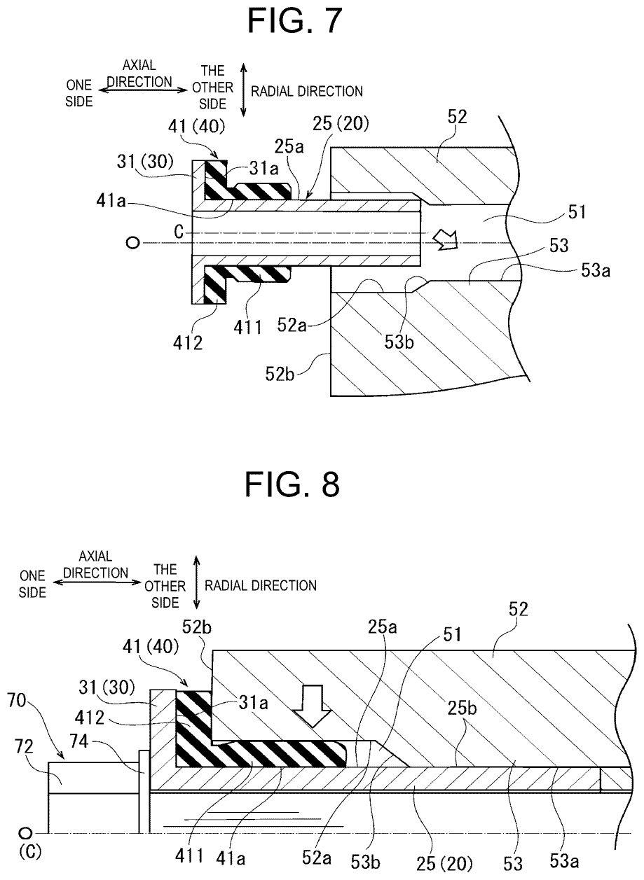

In the compressor 2, as illustrated in FIG. 7, an integral body of the first vibration-proof elastic member 41 mounted on the first sleeve 25 by press-fitting is inserted into the through hole 51 of the mounting foot 52 from the one axial side. At this time, if a central axis C of the first sleeve 25 is shifted in the radial direction with respect to the central axis O of the mounting foot 52, an insertion-side distal end portion of the first sleeve 25 is brought into contact with and slid on the first tapered inner peripheral surface 53b, thereby facilitating the insertion of the first sleeve 25 into the through hole 51. Similarly, when an integral body of the second sleeve 22 and the second vibration-proof elastic member 42 is inserted into the through hole 51 of the mounting foot 52 from the other axial side, an insertion-side distal end portion of the second sleeve 26 is brought into contact with and slid on the second tapered inner peripheral surface 53c, thereby facilitating the insertion of the second sleeve 26 into the through hole 51.

As illustrated in FIG. 5, in a state where the mounting foot 52 is fastened to the mounting target 60, the first tubular portion 411 of the first vibration-proof elastic member 41 is compressed in the radial direction between the inner peripheral surface 52a of the mounting foot 52 and the first outer peripheral surface 25a of the first sleeve 25, and the first disk portion 412 of the first vibration-proof elastic member 41 is compressed in the axial direction between a first mounting foot end surface 52b of the mounting foot 52 and the first flange end surface 31a of the first flange 31. The same applies to the second vibration-proof elastic member 42, and the second tubular portion 421 is compressed in the radial direction between the inner peripheral surface 52a of the mounting foot 52 and the second outer peripheral surface 26a of the second sleeve 26, and the second disk portion 422 is compressed in the axial direction between a second mounting foot end surface 52c and the second flange end surface 32a.

As illustrated in FIG. 8, in the compressor 2, when the housing 10 greatly vibrates in the radial direction of the through hole 51 under severe vibration conditions, the inner peripheral contact surface 53a of the mounting-foot-side radial projection 53 comes into contact with the first sleeve-side radial facing surface 25b of the first sleeve 25 and the second sleeve-side radial facing surface 26b of the second sleeve 26 in association with the radial elastic deformation of the first tubular portion 411 and the second tubular portion 421. This restricts further radial deformation of the first tubular portion 411 of the first vibration-proof elastic member 41 and the second tubular portion 421 of the second vibration-proof elastic member 42. As a result, deformation limits of the first tubular portion 411 and the second tubular portion 421 in the radial direction are defined.

Therefore, the compressor 2 can suppress deterioration in the vibration-proof performance of the vibration-proof elastic member 40 even under severe vibration conditions.

Other configurations and effects are similar to those of the first embodiment.

### Third Embodiment

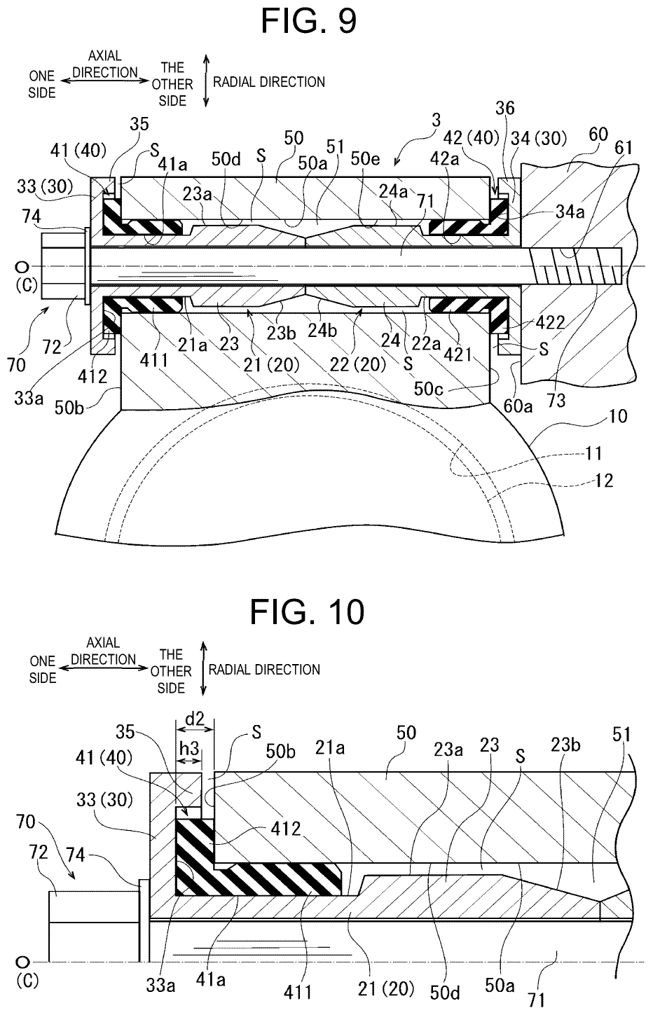

A compressor 3 of a third embodiment illustrated in FIG. 9 is a modification of the compressor 1 of the first embodiment. In the compressor 3, the pair of flanges 30 is a first flange 33 and a second flange 34. The first flange 33 and the second flange 34 are examples of the “annular plate” in the present disclosure.

The first sleeve 21 integrally includes the first flange 33, and the second sleeve 22 integrally includes the second flange 34.

The first flange 33 is integrally formed at the one axial end portion of the first sleeve 21. The first flange 33 protrudes radially outward from the one axial end portion of the first sleeve 21 and extends in a substantially disk shape. The first flange 33 includes a first flange-side axial projection 35. The first flange-side axial projection 35 is an example of an “axial projection” in the present disclosure.

The first flange-side axial projection 35 is provided at the outer peripheral end portion of the first flange 33. The first flange 33 includes a first flange end surface 33a axially facing the first mounting foot end surface 50b of the mounting foot 50. The first flange-side axial projection 35 annularly protrudes from the first flange end surface 33a toward the other axial side. In the axial direction, the first flange-side axial projection 35 faces the first mounting foot end surface 50b. The first flange end surface 33a is an example of an “annular plate end surface” in the present disclosure. The first mounting foot end surface 50b is an example of a “mounting foot end surface” in the present disclosure and is an example of an “axial facing surface” in the present disclosure.

The first flange-side axial projection 35 protrudes from the first flange end surface 33a by a predetermined protrusion length in the axial direction. As illustrated in FIG. 10, in the axial direction, a protrusion height h3 of the first flange-side axial projection 35 is ⅔ or more of a thickness d2 of the first disk portion 412 of the first vibration-proof elastic member 41 in both the fastened state of the mounting foot 50 to the mounting target 60 and the non-vibrating state of the housing 10. A predetermined gap S is provided in the axial direction between the first flange-side axial projection 35 and the first mounting foot end surface 50b axially facing the first flange-side axial projection 35.

The second flange 34 is integrally formed at the other axial end portion of the second sleeve 22. The second flange 34 protrudes radially outward from the other axial end portion of the second sleeve 22 and extends in a substantially disk shape. The second flange 34 includes a second flange-side axial projection 36. The second flange-side axial projection 36 is an example of the “axial projection” in the present disclosure.

The second flange-side axial projection 36 is provided at the outer peripheral end portion of the second flange 34. The second flange 34 includes a second flange end surface 34a axially facing the second mounting foot end surface 50c of the mounting foot 50. The second flange-side axial projection 36 annularly protrudes from the second flange end surface 34a toward the one axial side. In the axial direction, the second flange-side axial projection 36 faces the second mounting foot end surface 50c. The second flange end surface 34a is an example of the “annular plate end surface” in the present disclosure. The second mounting foot end surface 50c is an example of the “mounting foot end surface” in the present disclosure and is an example of the “axial facing surface” in the present disclosure.

The second flange-side axial projection 36 protrudes from the second flange end surface 34a by a predetermined protrusion length in the axial direction. In the axial direction, a protrusion height h3 of the second flange-side axial projection 36 is ⅔ or more of a thickness d2 of the second disk portion 422 of the second vibration-proof elastic member 42 in both the fastened state of the mounting foot 50 to the mounting target 60 and the non-vibrating state of the housing 10. As illustrated in FIG. 9, a predetermined gap S is provided in the axial direction between the second flange-side axial projection 36 and the second mounting foot end surface 50c axially facing the second flange-side axial projection 36.

The first sleeve 21 includes the first sleeve-side radial projection 23 similarly to the compressor 1 of the first embodiment. The second sleeve 22 includes the second sleeve-side radial projection 24 similarly to the compressor 1 of the first embodiment.

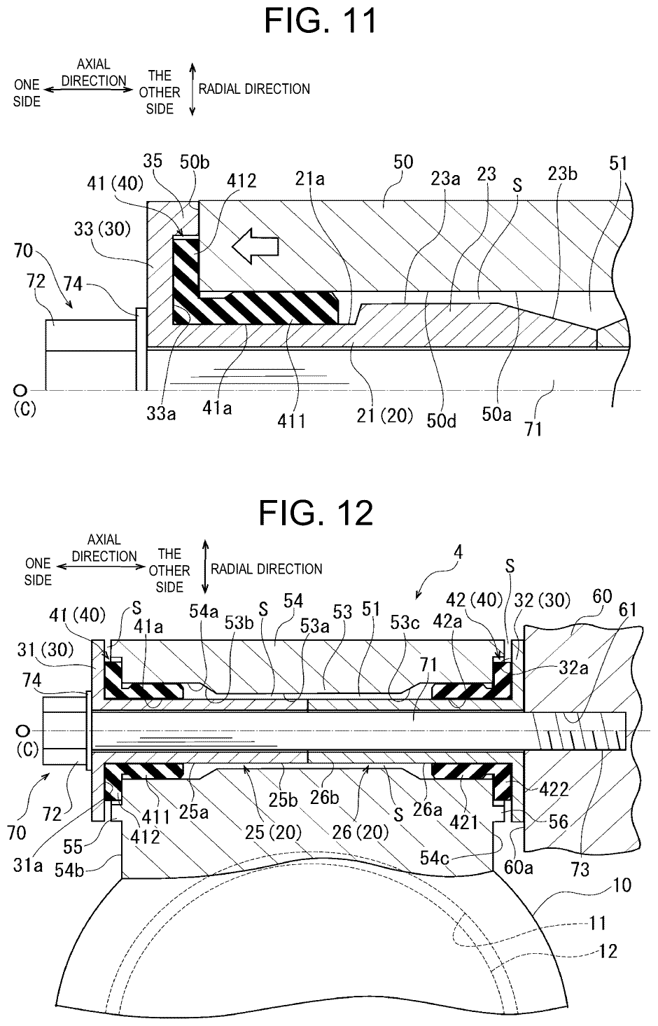

As illustrated in FIG. 11, in the compressor 3, when the housing 10 greatly vibrates in the axial direction of the through hole 51 under severe vibration conditions, the first flange-side axial projection 35 of the first flange 33 and the first mounting foot end surface 50b of the mounting foot 50 come into contact with each other in association with axial elastic deformation of the first disk portion 412, or the second flange-side axial projection 36 of the second flange 34 and the second mounting foot end surface 50c of the mounting foot 50 come into contact with each other in association with axial elastic deformation of the second disk portion 422. This restricts further axial deformation of the first disk portion 412 of the first vibration-proof elastic member 41 and the second disk portion 422 of the second vibration-proof elastic member 42. As a result, deformation limits of the first disk portion 412 and the second disk portion 422 in the axial direction are defined.

Further, in the compressor 3, similarly to the compressor 1 of the first embodiment, when the housing 10 greatly vibrates in the radial direction of the through hole 51 under severe vibration conditions, the first outer peripheral contact surface 23a of the first sleeve-side radial projection 23 and the first mounting-foot-side radial facing surface 50d come into contact with each other and the second outer peripheral contact surface 24a of the second sleeve-side radial projection 24 and the second mounting-foot-side radial facing surface 50e come into contact with each other in association with the radial elastic deformation of the first tubular portion 411 and the second tubular portion 421. This restricts further radial deformation of the first tubular portion 411 of the first vibration-proof elastic member 10) 41 and the second tubular portion 421 of the second vibration-proof elastic member 42. As a result, deformation limits of the first tubular portion 411 and the second tubular portion 421 in the radial direction are defined.

Therefore, the compressor 3 can suppress deterioration in the vibration-proof performance of the vibration-proof elastic member 40 even under severe vibration conditions.

Other configurations and effects are similar to those of the first embodiment.

### Fourth Embodiment

A compressor 4 of a fourth embodiment illustrated in FIG. 12 is a modification of the compressor 2 of the second embodiment and is a modification of the compressor 3 of the third embodiment.

In the compressor 4, similarly to the compressor 2 of the second embodiment, the pair of sleeves 20 is the first sleeve 25 and the second sleeve 26. The first sleeve 25 has a cylindrical shape extending in the axial direction with a constant outer diameter, and integrally includes the first flange 31 of a disk-shape at the one axial end portion. Similarly, the second sleeve 26 has a cylindrical shape extending in the axial direction with a constant outer diameter, and integrally includes the second flange 32 of a disk-shape at the other axial end portion.

In the compressor 4, a mounting foot 54 includes the mounting-foot-side radial projection 53, a first mounting-foot-side axial projection 55, and a second mounting-foot-side axial projection 56. The first mounting-foot-side axial projection 55 and the second mounting-foot-side axial projection 56 are examples of the “axial projection” in the present disclosure.

The mounting-foot-side radial projection 53 is provided on an inner peripheral surface 54a of the mounting foot 54. The mounting-foot-side radial projection 53 of the compressor 4 has a similar configuration to the mounting-foot-side radial projection 53 of the compressor 2 of the second embodiment.

The first mounting-foot-side axial projection 55 is provided on a first mounting foot end surface 54b of the mounting foot 54. The first mounting-foot-side axial projection 55 annularly protrudes from the first mounting foot end surface 54b toward the one axial side. In the axial direction, the first mounting-foot-side axial projection 55 faces the first flange end surface 31a of the first flange 31. The first mounting foot end surface 54b is an example of the “mounting foot end surface” in the present disclosure. The first flange end surface 31a is an example of the “annular plate end surface” in the present disclosure and is an example of the “axial facing surface” in the present disclosure.

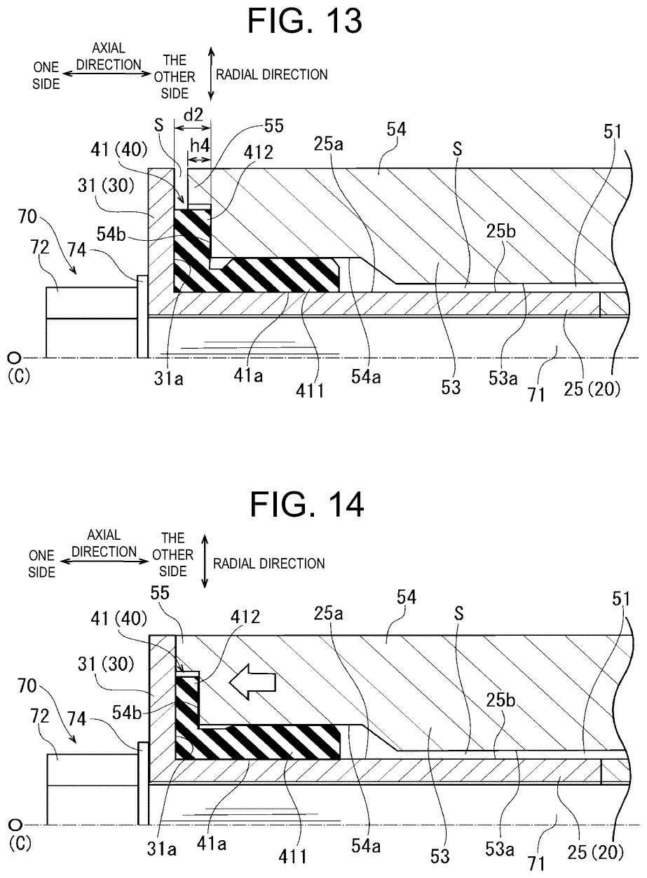

The first mounting-foot-side axial projection 55 protrudes in the axial direction from the first mounting foot end surface 54b of the mounting foot 54 by a predetermined protrusion length. As illustrated in FIG. 13, in the axial direction, a protrusion height h4 of the first mounting-foot-side axial projection 55 is ⅔ or more of the thickness d2 of the first disk portion 412 of the first vibration-proof elastic member 41 in both a fastened state of the mounting foot 54 to the mounting target 60 and the non-vibrating state of the housing 10. A predetermined gap S is provided in the axial direction between the first mounting-foot-side axial projection 55 and the first flange end surface 31a axially facing the first mounting-foot-side axial projection 55.

The second mounting-foot-side axial projection 56 is provided on a second mounting foot end surface 54c of the mounting foot 54. The second mounting-foot-side axial projection 56 annularly protrudes from the second mounting foot end surface 54c toward the other axial side. In the axial direction, the second mounting-foot-side axial projection 56 faces the second flange end surface 32a of the second flange 32. The second mounting foot end surface 54c is an example of the “mounting foot end surface” in the present disclosure. The second flange end surface 32a is an example of the “annular plate end surface” in the present disclosure and is an example of the “axial facing surface” in the present disclosure.

The second mounting-foot-side axial projection 56 protrudes in the axial direction from the second mounting foot end surface 54c of the mounting foot 54 by a predetermined protrusion length. In the axial direction, a protrusion height h4 of the second mounting-foot-side axial projection 56 is ⅔ or more of the thickness d2 of the second disk portion 422 of the second vibration-proof elastic member 42 in both the fastened state of the mounting foot 54 to the mounting target 60 and the non-vibrating state of the housing 10. As illustrated in FIG. 12, a predetermined gap S is provided in the axial direction between the second mounting-foot-side axial projection 56 and the second flange end surface 32a axially facing the second mounting-foot-side axial projection 56.

As illustrated in FIG. 14, in the compressor 4, when the housing 10 greatly vibrates in the axial direction of the through hole 51 under severe vibration conditions, the first mounting-foot-side axial projection 55 of the mounting foot 54 and the first flange end surface 31a of the first flange 31 come into contact with each other in association with the axial elastic deformation of the first disk portion 412, or the second mounting-foot-side axial projection 56 of the mounting foot 54 and the second flange end surface 32a of the second flange 32 come into contact with each other in association with the axial elastic deformation of the second disk portion 422. This restricts further axial deformation of the first disk portion 412 of the first vibration-proof elastic member 41 and the second disk portion 422 of the second vibration-proof elastic member 42. As a result, deformation limits of the first disk portion 412 and the second disk portion 422 in the axial direction are defined.

Further, in the compressor 4, similarly to the compressor 2 of the second 5 embodiment, when the housing 10 greatly vibrates in the radial direction of the through hole 51 under severe vibration conditions, the inner peripheral contact surface 53a of the mounting-foot-side radial projection 53 comes into contact with the first sleeve-side radial facing surface 25b of the first sleeve 25 and the second sleeve-side radial facing surface 26b of the second sleeve 26 in association with the radial elastic deformation of the first tubular portion 411 and the second tubular portion 421. This restricts further radial deformation of the first tubular portion 411 of the first vibration-proof elastic member 41 and the second tubular portion 421 of the second vibration-proof elastic member 42. As a result, deformation limits of the first tubular portion 411 and the second tubular portion 421 in the radial direction are defined. 15

Therefore, the compressor 4 can suppress deterioration in the vibration-proof performance of the vibration-proof elastic member 40 even under severe vibration conditions.

Other configurations and effects are similar to those of the second embodiment and the third embodiment.

### Fifth Embodiment

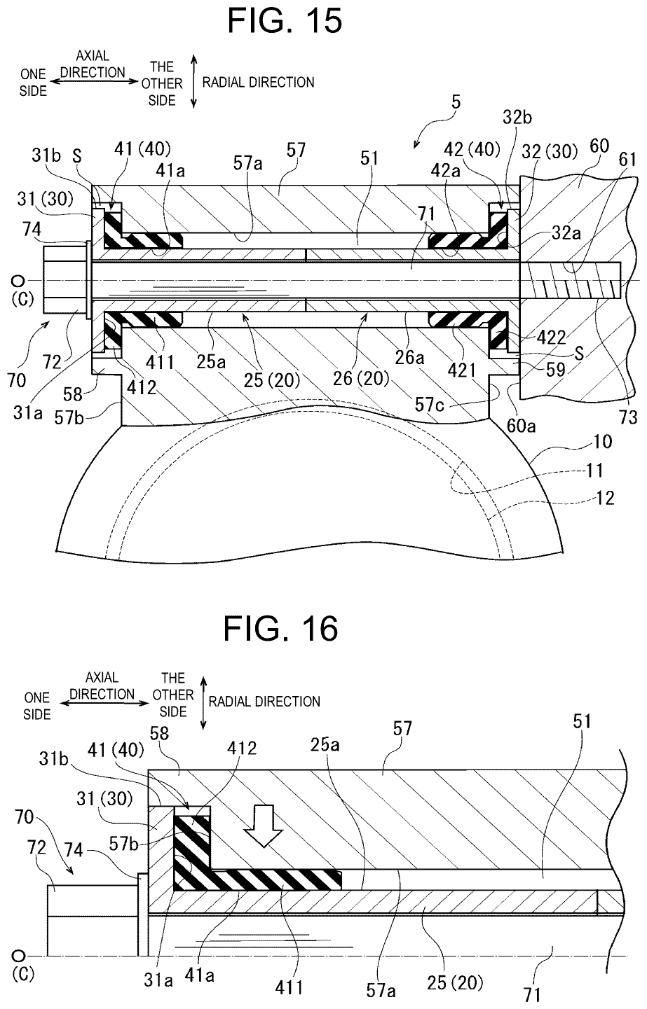

A compressor 5 of a fifth embodiment illustrated in FIG. 15 is a modification of the compressor 1 of the first embodiment.

In the compressor 5, an inner peripheral surface 57a of a mounting foot 57 extends over the entire through hole 51 in the axial direction with a constant inner diameter, similarly to the inner peripheral surface 50a of the mounting foot 50 in the compressor 1 of the first embodiment.

In the compressor 5, similarly to the compressor 2 of the second embodiment, the pair of sleeves 20 is the first sleeve 25 and the second sleeve 26. The first sleeve 25 has a cylindrical shape extending in the entire axial direction with a constant outer diameter, and integrally includes the first flange 31 of a disk-shape at the one axial end portion. Similarly, the second sleeve 26 has a cylindrical shape extending in the entire axial direction with a constant outer diameter, and integrally includes the second flange 32 of a disk-shape at the other axial end portion.

In the compressor 5, the mounting foot 57 includes a first axial extension portion 58 and a second axial extension portion 59. The first axial extension portion 58 and the second axial extension portion 59 are examples of an “axial extension portion” in the present disclosure.

The first axial extension portion 58 is provided on a first mounting foot end surface 57b of the mounting foot 57. The first mounting foot end surface 57b is an example of the “mounting foot end surface” in the present disclosure. The first axial extension portion 58 annularly extends from the first mounting foot end surface 57b toward the one axial side.

The first axial extension portion 58 extends in the axial direction from the first mounting foot end surface 57b to a position overlapping the first flange 31 in the radial direction. The first axial extension portion 58 radially faces a first flange outer peripheral facing surface 31b that is the outer peripheral surface of the first flange 31. The first flange outer peripheral facing surface 31b is an example of an “outer peripheral facing surface” in the present disclosure. A predetermined gap S is provided in the radial direction between the first axial extension portion 58 and the first flange outer peripheral facing surface 31b.

The second axial extension portion 59 is provided on a second mounting foot end surface 57c of the mounting foot 57. The second mounting foot end surface 57c is an example of the “mounting foot end surface” in the present disclosure. The second axial extension portion 59 annularly extends from the second mounting foot end surface 57c toward the other axial side.

The second axial extension portion 59 extends in the axial direction from the second mounting foot end surface 57c to a position overlapping the second flange 32 in the radial direction. The second axial extension portion 59 radially faces a second flange outer peripheral facing surface 32b that is the outer peripheral surface of the second flange 32. The second flange outer peripheral facing surface 32b is an example of the “outer peripheral facing surface” in the present disclosure. A predetermined gap S is provided in the radial direction 10) between the second axial extension portion 59 and the second flange outer peripheral facing surface 32b.

As illustrated in FIG. 16, in the compressor 5, when the housing 10 greatly vibrates in the radial direction of the through hole 51 under severe vibration conditions, the first axial extension portion 58 and the first flange outer peripheral facing surface 31b come into contact with each other and the second axial extension portion 59 and the second flange outer peripheral facing surface 32b come into contact with each other in association with the radial elastic deformation of the first tubular portion 411 and the second tubular portion 421. This restricts further radial deformation of the first tubular portion 411 of the first vibration-proof elastic member 41 and the second tubular portion 421 of the second vibration-proof elastic member 42. As a result, deformation limits of the first tubular portion 411 and the second tubular portion 421 in the radial direction are defined.

Therefore, the compressor 5 can suppress deterioration in the vibration-proof performance of the vibration-proof elastic member 40 even under severe vibration conditions.

Other configurations and effects are similar to those of the first embodiment.

### Sixth Embodiment

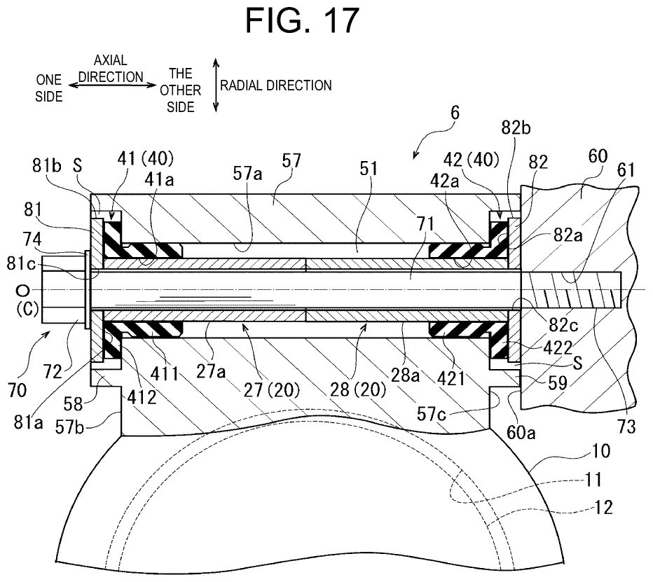

A compressor 6 of a sixth embodiment illustrated in FIG. 17 is a modification of the compressor 5 of the fifth embodiment.

The compressor 6 includes a first annular plate 81 and a second annular plate 82 instead of the first flange 31 and the second flange 32 in the compressor 5 of the fifth embodiment. The first annular plate 81 and the second annular plate 82 are examples of the “annular plate” in the present disclosure.

In the compressor 6, the pair of sleeves 20 is a first sleeve 27 and a second sleeve 28.

The first sleeve 27 has a cylindrical shape with a first outer peripheral surface 27a extending in the entire axial direction with a constant outer diameter. The first sleeve 27 does not integrally include the first flange 31 at one axial end portion. The first annular plate 81 as a separate body from the first sleeve 27 is disposed closer to the one axial side than the first sleeve 27 is. In a fastened state in which the mounting foot 57 is fastened to the mounting target 60, the first annular plate 81 is in contact with one axial end surface of the first sleeve 27.

The second sleeve 28 has a cylindrical shape with a second outer peripheral surface 28a extending in the entire axial direction with a constant outer diameter. The second sleeve 28 does not integrally include the second flange 32 at the other axial end portion. The second annular plate 82 as a separate body from the second sleeve 28 is disposed closer to the other axial side than the second sleeve 28 is. The second annular plate 82 is in contact with the other axial end surface of the second sleeve 28 in the fastened state where the mounting foot 57 is fastened to the mounting target 60.

Instead of the first sleeve 27 and the second sleeve 28, one cylindrical sleeve extending over the entire axial direction with a constant outer diameter may be used.

The first annular plate 81 includes a first annular plate end surface 81a axially facing the first mounting foot end surface 57b. The first annular plate 81 is located closer to the one axial side than the first disk portion 412 of the first vibration-proof elastic member 41 is. The first annular plate 81 includes a first through hole 81c having an inner diameter equal to the inner diameter of the first sleeve 27. The shaft portion 71 of the fastening member 70 is inserted into the first through hole 81c.

A predetermined gap S is provided in the radial direction between the first axial extension portion 58 and a first annular plate outer peripheral facing surface 81b radially facing the first axial extension portion 58. The first annular plate outer peripheral facing surface 81b is an example of the “outer peripheral facing surface” in the present disclosure.

The second annular plate 82 includes a second annular plate end surface 82a axially facing the second mounting foot end surface 57c. The second annular plate 82 is located closer to the other axial side than the second disk portion 422 of the second vibration-proof elastic member 42 is. The second annular plate 82 includes a second through hole 82c having an inner diameter equal to the inner 20 diameter of the second sleeve 28. The shaft portion 71 of the fastening member 70 is inserted into the second through hole 82c.

A predetermined gap S is provided in the radial direction between the second axial extension portion 59 and a second annular plate outer peripheral facing surface 82b radially facing the second axial extension portion 59. The second annular plate outer peripheral facing surface 82b is an example of the “outer peripheral facing surface” in the present disclosure.

Other configurations of the compressor 6 are similar to those of the compressor 5 of the fifth embodiment, and the compressor 6 has similar effects to those of the compressor 5 of the fifth embodiment.

### Seventh Embodiment

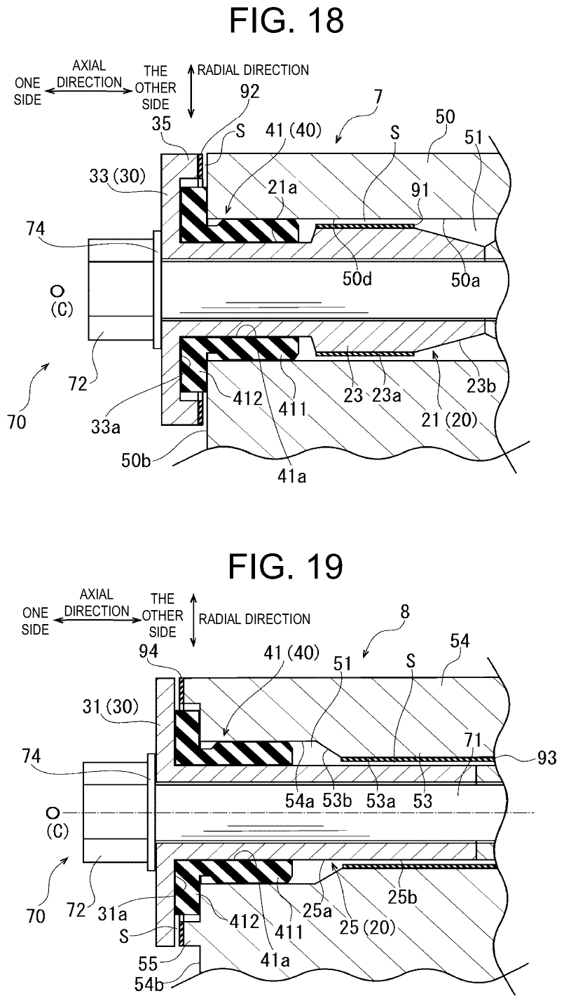

A compressor 7 of a seventh embodiment illustrated in FIG. 18 is a modification of the compressor 3 of the third embodiment.

In the compressor 7, a first elastic film 91 that buffers contact with the first mounting-foot-side radial facing surface 50d is formed on the first outer peripheral contact surface 23a of the first sleeve-side radial projection 23 in the first sleeve 21. The first elastic film 91 is an example of an “elastic film” in the present disclosure.

The first elastic film 91 is formed on the entire first outer peripheral contact surface 23a in the axial direction. The first elastic film 91 is formed by bonding a cylindrical rubber film to the first outer peripheral contact surface 23a.

Although not illustrated, the first elastic film 91 that buffers contact with the second mounting-foot-side radial facing surface 50e is formed on the second outer peripheral contact surface 24a of the second sleeve-side radial projection 24 of the second sleeve 22.

Note that the first elastic film 91 may be formed not on the first outer peripheral contact surface 23a but on the first mounting-foot-side radial facing surface 50d that comes into contact with the first outer peripheral contact surface 23a in the radial direction. Similarly, the first elastic film 91 may be formed not on the second outer peripheral contact surface 24a but on the second mounting-foot-side radial facing surface 50e that comes into contact with the second outer peripheral contact surface 24a in the radial direction.

The first flange-side axial projection 35 of the first flange 33 is provided with a second elastic film 92 that buffers contact with the first mounting foot end surface 50b. The second elastic film 92 is an example of the “elastic film” in the present disclosure.

The second elastic film 92 is formed on the entire protruding distal end surface of the first flange-side axial projection 35. The second elastic film 92 is formed by bonding a ring-plate-shaped rubber film to the protruding distal end surface of the first flange-side axial projection 35.

Although not illustrated, the second elastic film 92 that buffers contact with the second mounting foot end surface 50c is formed on the second flange-side axial projection 36 of the second flange 34.

Note that the second elastic film 92 may be formed not on the first flange-side axial projection 35 but on the first mounting foot end surface 50b in axial contact with the first flange-side axial projection 35. Similarly, the second elastic film 92 may be formed not on the second flange-side axial projection 36 but on the second mounting foot end surface 50c in axial contact with the second flange-side axial projection 36.

In the compressor 7, when the housing 10 greatly vibrates in the radial direction of the through hole 51 under severe vibration conditions, the first elastic film 91 can suppress contact noise generated upon contact between the first sleeve-side radial projection 23 and the first mounting-foot-side radial facing surface 50d, and contact noise generated upon contact between the second sleeve-side radial projection 24 and the second mounting-foot-side radial facing surface 50e.

Further, when the housing 10 greatly vibrates in the axial direction of the through hole 51 under severe vibration conditions, the second elastic film 92 can suppress contact noise generated upon contact between the first flange-side axial projection 35 and the first mounting foot end surface 50b, and contact noise generated upon contact between the second flange-side axial projection 36 and the second mounting foot end surface 50c.

Other configurations and effects are similar to those of the third embodiment.

### Eighth Embodiment

A compressor 8 of an eighth embodiment illustrated in FIG. 19 is a modification of the compressor 4 of the fourth embodiment.

In the compressor 8, a third elastic film 93 that buffers contact with the first sleeve-side radial facing surface 25b of the first sleeve 25 and contact with the second sleeve-side radial facing surface 26b of the second sleeve 26 is formed on the inner peripheral contact surface 53a of the mounting-foot-side radial projection 53 of the mounting foot 54. The third elastic film 93 is an example of the “elastic film” in the present disclosure.

The third elastic film 93 is formed on the entire inner peripheral contact surface 53a in the axial direction. The third elastic film 93 is formed by bonding a cylindrical rubber film to the inner peripheral contact surface 53a.

Note that the third elastic film 93 may be formed not on the inner peripheral contact surface 53a but each on the first sleeve-side radial facing surface 25b of the first sleeve 25 and on the second sleeve-side radial facing surface 26b of the second sleeve 26.

A fourth elastic film 94 that buffers contact with the first flange end surface 31a of the first flange 31 is formed on the protruding distal end surface of the first mounting-foot-side axial projection 55 of the mounting foot 54. The fourth elastic film 94 is an example of the “elastic film” in the present disclosure.

The fourth elastic film 94 is formed on the entire protruding distal end surface of the first mounting-foot-side axial projection 55. The fourth elastic film 94 is formed by bonding a ring-shaped rubber film to the protruding distal end surface of the first mounting-foot-side axial projection 55.

Although not illustrated, the fourth elastic film 94 that buffers contact with the second flange end surface 32a of the second flange 32 is formed on the protruding distal end surface of the second mounting-foot-side axial projection 56 of the mounting foot 54.

Note that the fourth elastic film 94 may be formed not on the first mounting-foot-side axial projection 55 but on the first flange end surface 31a in contact with the first mounting-foot-side axial projection 55 in the axial direction. Similarly, the fourth elastic film 94 may be formed not on the second mounting-foot-side axial projection 56 but on the second flange end surface 32a in contact with the second 10) mounting-foot-side axial projection 56 in the axial direction.

In the compressor 8, when the housing 10 greatly vibrates in the radial direction of the through hole 51 under severe vibration conditions, the third elastic film 93 can suppress contact noise generated upon contact between the mounting-foot-side radial projection 53 and the first sleeve-side radial facing surface 25b, and between the mounting-foot-side radial projection 53 and the second sleeve-side radial facing surface 26b.

Further, when the housing 10 greatly vibrates in the axial direction of the through hole 51 under severe vibration conditions, the fourth elastic film 94 can suppress contact noise generated upon contact between the first mounting-foot-side axial projection 55 and the first flange end surface 31a, and contact noise generated upon contact between the second mounting-foot-side axial projection 56 and the second flange end surface 32a. 25

Other configurations and effects are similar to those of the fourth embodiment.

### Ninth Embodiment

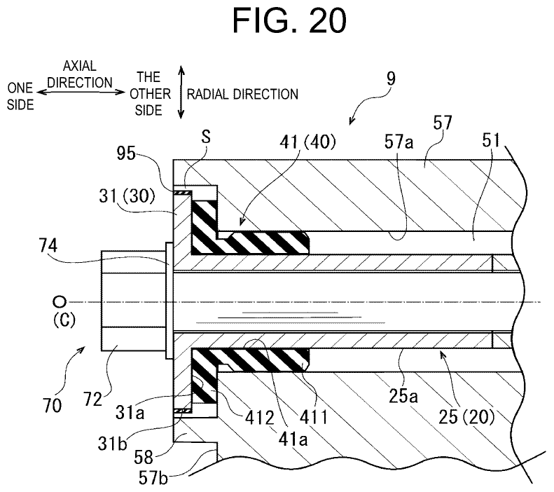

A compressor 9 of a ninth embodiment illustrated in FIG. 20 is a modification of the compressor 5 of the fifth embodiment.

In the compressor 9, a fifth elastic film 95 that buffers contact with the first axial extension portion 58 is formed on the first flange outer peripheral facing surface 31b of the first flange 31. The fifth elastic film 95 is an example of the “elastic film” in the present disclosure.

The fifth elastic film 95 is formed on the entire first flange outer peripheral facing surface 31b. The fifth elastic film 95 is formed by bonding a cylindrical rubber film to the first flange outer peripheral facing surface 31b.

Although not illustrated, the fifth elastic film 95 that buffers contact with the second axial extension portion 59 is formed on the second flange outer peripheral facing surface 32b of the second flange 32.

Note that the fifth elastic film 95 may be formed not on the first flange outer peripheral facing surface 31b but on the first axial extension portion 58 in contact with the first flange outer peripheral facing surface 31b in the radial direction. Similarly, the fifth elastic film 95 may be formed not on the second flange outer peripheral facing surface 32b but on the second axial extension portion 59 in contact with the second flange outer peripheral facing surface 32b in the radial direction.

In the compressor 9, when the housing 10 greatly vibrates in the radial direction of the through hole 51 under severe vibration conditions, the fifth elastic film 95 can suppress contact noise generated upon contact between the first axial extension portion 58 and the first flange outer peripheral facing surface 31b, and contact noise generated upon contact between the second axial extension portion 59 and the second flange outer peripheral facing surface 32b.

Other configurations and effects are similar to those of the fifth embodiment.

In the above, the present disclosure has been described in accordance with the first to ninth embodiments, but the present disclosure is not limited to the first to ninth embodiments described above, and it goes without saying that the present disclosure can be appropriately modified and applied without departing from the gist thereof.

In the first to ninth embodiments, the first vibration-proof elastic member 41 formed integrally with the first tubular portion 411 and the first disk portion 412 has been used, but the present disclosure is not limited thereto, and the first tubular portion 411 and the first disk portion 412 may be separate bodies. The same applies to the second vibration-proof elastic member 42.

In the first to ninth embodiments, the first vibration-proof elastic member 41 formed integrally with the first tubular portion 411 and the first disk portion 412 has been used, but the present disclosure is not limited thereto. For example, the first vibration-proof elastic member may include only a first tubular portion having a simple cylindrical shape without a first disk portion. However, in this case, it is necessary to provide, on the inner peripheral surface of the mounting foot, a restricting portion for restricting the end surface of the first vibration-proof elastic member and compressing the first vibration-proof elastic member in the axial direction between the first annular plate and the restricting portion. The same applies to the second vibration-proof elastic member 42.

In the first to fourth embodiments and the seventh to ninth embodiments, the first sleeve integrally including the first flange as the first annular plate and the second sleeve integrally including the second flange as the second annular plate have been used, but the present disclosure is not limited thereto. For example, in the first to fourth embodiments and the seventh to ninth embodiments, a first sleeve of a cylindrical shape, a first annular plate as a separate body from the cylindrical first sleeve, a second sleeve of a cylindrical shape, and a second annular plate as a separate body from the cylindrical second sleeve may be used, or one cylindrical sleeve, as well as the first annular plate and the second annular plate as separate bodies from the sleeve, may be used. Furthermore, in these cases, the washer 74 of the fastening member 70 set to a predetermined size may be used in combination as the first annular plate.

Similarly, in the sixth embodiment, the washer 74 of the fastening member 70 set to a predetermined size may be used in combination as an annular plate in contact with the first axial extension portion 58 in the radial direction.

In the seventh embodiment, at least one of the first elastic film 91 and the second elastic film 92 may be integrally formed with the first vibration-proof elastic member 41 by vulcanization bonding, or at least one of the first elastic film 91 and the second elastic film 92 may be integrally formed with the second vibration-proof elastic member 42 by vulcanization bonding.

Similarly, in the ninth embodiment, the fifth elastic film 95 and the first vibration-proof elastic member 41 may be integrally formed by vulcanization bonding, or the fifth elastic film 95 and the second vibration-proof elastic member 42 may be integrally formed by vulcanization bonding.

In the second, fourth, and eighth embodiments, the first flange 31 may be a first annular plate as a separate body from the first sleeve 25, and in this case, the first tapered inner peripheral surface 53b may be omitted in the mounting-foot-side radial projection 53. Similarly, in the second, fourth, and eighth embodiments, the second flange 32 may be a second annular plate as a separate body from the second sleeve 26, and in this case, the second tapered inner peripheral surface 53c may be omitted in the mounting-foot-side radial projection 53. Further, in the second, fourth, and eighth embodiments, both the first flange 31 and the second flange 32 may be a first annular plate and a second annular plate as separate bodies from the sleeve, and in this case, one of the first tapered inner peripheral surface 53b and the second tapered inner peripheral surface 53c may be omitted in the mounting-foot-side radial projection 53.

The following technical ideas can be extracted from the disclosure of the specification, the drawings, and the like.

### (Supplement 1)

A compressor comprising:
a housing that includes an accommodation portion accommodating a compression unit that compresses a fluid, and a mounting foot in which a through hole is formed;
a sleeve that is disposed inside the through hole and through which a fastening member for fastening the mounting foot to a mounting target is inserted, the sleeve having a tubular shape;
a pair of vibration-proof elastic members disposed at both end portions of the through hole in an axial direction of the through hole and each including a tubular portion that is disposed between an inner peripheral surface of the mounting foot and an outer peripheral surface of the sleeve; and
a pair of annular plates integrated with or separated from the sleeve and disposed outside the vibration-proof elastic member in the axial direction, the pair of annular plates extending in a radial direction orthogonal to the axial direction,
the vibration-proof elastic member being compressed in the axial direction between the mounting foot and the annular plate, the vibration-proof elastic member being compressed in the radial direction between the mounting foot and the sleeve, the compressor being characterized in that
one of the inner peripheral surface of the mounting foot and the outer peripheral surface of the sleeve is provided with a radial projection that protrudes in the radial direction toward the other of the inner peripheral surface of the mounting foot and the outer peripheral surface of the sleeve, and
when the housing vibrates, a deformation limit of the vibration-proof elastic member in the radial direction is defined by the radial projection coming into contact with a radial facing surface of the other that faces the radial projection in the radial direction, in association with deformation of the vibration-proof elastic member.

### (Supplement 2)

The compressor according to supplement 1, characterized in that
the sleeve includes a first sleeve disposed at one end portion of the through hole in the axial direction and a second sleeve disposed at the other end portion of the through hole in the axial direction,
the pair of annular plates is a first flange that integrally protrudes in the radial direction from one end portion of the first sleeve in the axial direction and a second flange that integrally protrudes in the radial direction from the other end portion of the second sleeve in the axial direction,
the radial projection includes a first sleeve-side radial projection provided on an outer peripheral surface of the first sleeve and a second sleeve-side radial projection provided on an outer peripheral surface of the second sleeve,
the pair of vibration-proof elastic members is a first vibration-proof elastic member disposed between the first flange and the first sleeve-side radial projection in the axial direction, and a second vibration-proof elastic member disposed between the second flange and the second sleeve-side radial projection in the axial direction,
a first tapered outer peripheral surface is formed at the other end portion of the first sleeve-side radial projection in the axial direction, the first tapered outer peripheral surface being tapered toward a distal end of the first sleeve-side radial projection in the axial direction, and
a second tapered outer peripheral surface is formed at one end portion of the second sleeve-side radial projection in the axial direction, the second tapered outer peripheral surface being tapered toward a distal end of the second sleeve-side radial projection in the axial direction.

### (Supplement 3)

The compressor according to supplement 1 or 2, characterized in that
the radial projection is a mounting-foot-side radial projection provided on the inner peripheral surface of the mounting foot, and
a tapered inner peripheral surface is formed at one end portion of the mounting-foot-side radial projection in the axial direction, the tapered inner peripheral surface having an inner diameter decreasing from one end to the other end of the mounting-foot-side radial projection in the axial direction.

### (Supplement 4)

The compressor according to any one of supplements 1 to 3, characterized in that
one of the radial projection and the radial facing surface is provided with an elastic film that buffers contact between the radial projection and the radial facing surface.

### (Supplement 5)

The compressor according to any one of supplements 1 to 4, characterized in that
a protrusion height of the radial projection is ⅔ or more of a thickness of the tubular portion in the radial direction in both a fastened state of the mounting foot to the mounting target and a non-vibrating state of the housing.

### (Supplement 6)

A compressor comprising:
a housing that includes an accommodation portion accommodating a compression unit that compresses a fluid, and a mounting foot in which a through hole is formed;
a sleeve that is disposed inside the through hole and through which a fastening member for fastening the mounting foot to a mounting target is inserted, the sleeve having a tubular shape;
a pair of vibration-proof elastic members disposed at both end portions of the through hole in an axial direction of the through hole and each including a tubular portion that is disposed between an inner peripheral surface of the mounting foot and an outer peripheral surface of the sleeve; and
a pair of annular plates integrated with or separated from the sleeve and disposed outside the vibration-proof elastic member in the axial direction, the pair of annular plates extending in a radial direction orthogonal to the axial direction,
the vibration-proof elastic member being compressed in the axial direction between the mounting foot and the annular plate, the vibration-proof elastic member being compressed in the radial direction between the mounting foot and the sleeve, the compressor being characterized in that
one of a mounting foot end surface of the mounting foot in the axial direction and an annular plate end surface of the annular plate facing the mounting foot in the axial direction is provided with an axial projection that protrudes in the axial direction toward the other of the mounting foot end surface and the annular plate end surface, and
when the housing vibrates, a deformation limit of the vibration-proof elastic member in the axial direction is defined by the axial projection coming into contact with an axial facing surface of the other that faces the axial projection in the axial direction, in association with deformation of the vibration-proof elastic member.

### (Supplement 7)

The compressor according to supplement 6, characterized in that
an elastic film that buffers contact between the axial projection and the axial facing surface is provided on one of the axial projection and the axial facing surface.

### (Supplement 8)

A compressor comprising:
a housing that includes an accommodation portion accommodating a compression unit that compresses a fluid, and a mounting foot in which a through hole is formed;
a sleeve that is disposed inside the through hole and through which a fastening member for fastening the mounting foot to a mounting target is inserted, the sleeve having a tubular shape;
a pair of vibration-proof elastic members disposed at both end portions of the through hole in an axial direction of the through hole and each including a tubular portion that is disposed between an inner peripheral surface of the mounting foot and an outer peripheral surface of the sleeve; and
a pair of annular plates integrated with or separated from the sleeve and disposed outside the vibration-proof elastic member in the axial direction, the pair of annular plates extending in a radial direction orthogonal to the axial direction,
the vibration-proof elastic member being compressed in the axial direction between the mounting foot and the annular plate, the vibration-proof elastic member being compressed in the radial direction between the mounting foot and the sleeve, the compressor being characterized in that
an axial extension portion that extends in the axial direction is provided on a mounting foot end surface of the mounting foot in the axial direction, and
when the housing vibrates, a deformation limit of the vibration-proof elastic member in the radial direction is defined by the axial extension portion coming into contact with an outer peripheral facing surface of the annular plate that faces the axial extension portion in the radial direction, in association with deformation of the vibration-proof elastic member.

### (Supplement 9)

The compressor according to supplement 8, characterized in that
one of the axial extension portion and the outer peripheral facing surface is provided with an elastic film that buffers contact between the axial extension portion and the outer peripheral facing surface.

The present disclosure is applicable to a vehicle such as a transportation vehicle and an industrial vehicle in addition to a passenger car.

What is claimed is:

1. A compressor comprising:
a housing that includes an accommodation portion accommodating a compression unit that compresses a fluid, and a mounting foot in which a through hole is formed;
a sleeve that is disposed inside the through hole and through which a fastening member for fastening the mounting foot to a mounting target is inserted, the sleeve having a tubular shape;
a pair of vibration-proof elastic members disposed at both end portions of the through hole in an axial direction of the through hole and each including a tubular portion that is disposed between an inner peripheral surface of the mounting foot and an outer peripheral surface of the sleeve; and
a pair of annular plates integrated with or separated from the sleeve and disposed outside the vibration-proof elastic members in the axial direction, the pair of annular plates extending in a radial direction orthogonal to the axial direction,
the vibration-proof elastic members being compressed in the axial direction between the mounting foot and the annular plates, the vibration-proof elastic members being compressed in the radial direction between the mounting foot and the sleeve, wherein
one of the inner peripheral surface of the mounting foot and the outer peripheral surface of the sleeve is provided with a radial projection that protrudes in the radial direction toward the other of the inner peripheral surface of the mounting foot and the outer peripheral surface of the sleeve, and
when the housing vibrates, deformation limits of the vibration-proof elastic members in the radial direction are defined by the radial projection coming into contact with a radial facing surface of the other that faces the radial projection in the radial direction, in association with deformation of the vibration-proof elastic members.

2. The compressor according to claim 1, wherein
the sleeve includes a first sleeve disposed at one end portion of the through hole in the axial direction and a second sleeve disposed at the other end portion of the through hole in the axial direction,
the pair of annular plates is a first flange that integrally protrudes in the radial direction from one end portion of the first sleeve in the axial direction and a second flange that integrally protrudes in the radial direction from the other end portion of the second sleeve in the axial direction,
the radial projection includes a first sleeve-side radial projection provided on an outer peripheral surface of the first sleeve and a second sleeve-side radial projection provided on an outer peripheral surface of the second sleeve,
the pair of vibration-proof elastic members is a first vibration-proof elastic member disposed between the first flange and the first sleeve-side radial projection in the axial direction, and a second vibration-proof elastic member disposed between the second flange and the second sleeve-side radial projection in the axial direction,
a first tapered outer peripheral surface is formed at the other end portion of the first sleeve-side radial projection in the axial direction, the first tapered outer peripheral surface being tapered toward a distal end of the first sleeve-side radial projection in the axial direction, and
a second tapered outer peripheral surface is formed at one end portion of the second sleeve-side radial projection in the axial direction, the second tapered outer peripheral surface being tapered toward a distal end of the second sleeve-side radial projection in the axial direction.

3. The compressor according to claim 1, wherein
the radial projection is a mounting-foot-side radial projection provided on the inner peripheral surface of the mounting foot, and
a tapered inner peripheral surface is formed at one end portion of the mounting-foot-side radial projection in the axial direction, the tapered inner peripheral surface having an inner diameter decreasing from one end to the other end of the mounting-foot-side radial projection in the axial direction.

4. The compressor according to claim 1, wherein
one of the radial projection and the radial facing surface is provided with an elastic film that buffers contact between the radial projection and the radial facing surface.

5. The compressor according to claim 1, wherein
a protrusion height of the radial projection is ⅔ or more of a thickness of the tubular portion in the radial direction in both a fastened state of the mounting foot to the mounting target and a non-vibrating state of the housing.

6. A compressor comprising:
a housing that includes an accommodation portion accommodating a compression unit that compresses a fluid, and a mounting foot in which a through hole is formed;
a sleeve that is disposed inside the through hole and through which a fastening member for fastening the mounting foot to a mounting target is inserted, the sleeve having a tubular shape;
a pair of vibration-proof elastic members disposed at both end portions of the through hole in an axial direction of the through hole and each including a tubular portion that is disposed between an inner peripheral surface of the mounting foot and an outer peripheral surface of the sleeve; and
a pair of annular plates integrated with or separated from the sleeve and disposed outside the vibration-proof elastic members in the axial direction, the pair of annular plates extending in a radial direction orthogonal to the axial direction,
the vibration-proof elastic members being compressed in the axial direction between the mounting foot and the annular plates, the vibration-proof elastic members being compressed in the radial direction between the mounting foot and the sleeve, wherein
one of a mounting foot end surface of the mounting foot in the axial direction and an annular plate end surface of the annular plate facing the mounting foot end surface in the axial direction is provided with an axial projection that protrudes in the axial direction toward the other of the mounting foot end surface and the annular plate end surface, and
when the housing vibrates, deformation limits of the vibration-proof elastic members in the axial direction are defined by the axial projection coming into contact with an axial facing surface of the other that faces the axial projection in the axial direction, in association with deformation of the vibration-proof elastic members.

7. The compressor according to claim 6, wherein
one of the axial projection and the axial facing surface is provided with an elastic film that buffers contact between the axial projection and the axial facing surface.

8. A compressor comprising:
a housing that includes an accommodation portion accommodating a compression unit that compresses a fluid, and a mounting foot in which a through hole is formed;
a sleeve that is disposed inside the through hole and through which a fastening member for fastening the mounting foot to a mounting target is inserted, the sleeve having a tubular shape;
a pair of vibration-proof elastic members disposed at both end portions of the through hole in an axial direction of the through hole and each including a tubular portion that is disposed between an inner peripheral surface of the mounting foot and an outer peripheral surface of the sleeve; and
a pair of annular plates integrated with or separated from the sleeve and disposed outside the vibration-proof elastic members in the axial direction, the pair of annular plates extending in a radial direction orthogonal to the axial direction,
the vibration-proof elastic members being compressed in the axial direction between the mounting foot and the annular plates, the vibration-proof elastic members being compressed in the radial direction between the mounting foot and the sleeve, wherein
an axial extension portion that extends in the axial direction is provided on a mounting foot end surface of the mounting foot in the axial direction, and
when the housing vibrates, deformation limits of the vibration-proof elastic members in the radial direction are defined by the axial extension portion coming into contact with an outer peripheral facing surface of the annular plate that faces the axial extension portion in the radial direction, in association with deformation of the vibration-proof elastic members.

9. The compressor according to claim 8, wherein
one of the axial extension portion and the outer peripheral facing surface is provided with an elastic film that buffers contact between the axial extension portion and the outer peripheral facing surface.
